(19) United States
(12) Patent Application Publication
(10) Pub. No.: US 2011/0072123 A1
(43) Pub. Date: Mar. 24, 2011

(54) AUTO-METER SYSTEM WITH CONTROLLER AREA NETWORK BUS

(76) Inventors: Yuan-Yong Hsu, Taipei City (TW); Hung-Yih Tsai, Yunlin County (TW); Chien-Nan Wu, Nantou County (TW); Wang-Chang Tsao, Yilan County (TW)

(21) Appl. No.: 12/632,770

(22) Filed: Dec. 7, 2009

(30) Foreign Application Priority Data
Sep. 18, 2009 (TW) 098131596

(51) Int. Cl. G06F 15/173

(52) U.S. Cl. 709/223

(57) ABSTRACT

An auto-meter system includes a CAN-Bus for transmitting a CAN-Bus signal, and a first CAN module coupled to the CAN-Bus. The first CAN module is for receiving the CAN-Bus signal transmitted from the CAN-Bus and for transforming the CAN-Bus signal to a message signal. The auto-meter system further includes a display and a processor coupled to the CAN module and the display. The processor is for receiving the message signal and for controlling the display to show information corresponding to the message signal.

### BACKGROUND OF THE INVENTION

1. Field of the Invention

The present invention relates to an auto-meter system, and more particularly, to an auto-meter system with a controller area network bus.

2. Description of the Prior Art

A conventional auto-meter utilizes a spindle force generated from a magnet and an iron cover and a non-magnetic conductor, such as aluminum and copper, to be a pointer rotator. A meter can be composed of the pointer rotator, a rotary spring, an integrator, and a rotary gear so that eddy currents of the pointer rotator and magnetic field of the magnet act with each other for driving the pointer rotator to rotate a pointer. Information shown by the pointer, a light emitting diode, and a digital screen of the conventional auto-meter are analyzed from a voltage signal or a resistance signal of a common sensor. When a vehicle drives on a rugged road, the conventional auto-meter is affected by external vibration easily and shakes irregularly. In addition, resolution of an induced circuit is limited to magnetic flux of the magnet, so that resolution of the conventional auto-meter can not be increased.

Recently, system units of the vehicle utilize electronic devices gradually. The main difficulty of the vehicle is that the conventional auto-meter, warning lamps, and instrument panels can not transmit signals accurately in a surrounding with interferences generated by large numbers of electronic components. In addition, assembly for cables of sensors on the vehicle, accuracy of transmitting the signals, and system service are complicated than before, so the conventional auto-meter is unable to be compatible with new generation electronic system.

The conventional auto-meter includes a drawback that the rotator is induced by the magnetic flux so as to rotate the pointer. Therefore, the external vibration of the vehicle affects the pointer, so that rotary accuracy of the pointer is limited to values of the magnetic flux, which is disadvantageous to control and adjust the pointer. In addition, the magnetic flux is controlled by analog control method and can not be applied on a digital electronic system. Due to resolution of the signals, the conventional auto-meter can not be compatible with the vehicle having a controller area network system, so that the conventional auto-meter can not receive and analyze the signals, which means the conventional auto-meter can not process signals. Therefore, the conventional auto-meter is unable to be compatible with the other electronic devices, and functions of the conventional auto-meter are limited to an initial setting and can not be applied on the other kinds of vehicles.

### SUMMARY OF THE INVENTION

The present invention provides an auto-meter system with a controller area network bus for solving above drawbacks.

According to the claimed invention, an auto-meter system includes a controller area network bus (CAN-Bus) for transmitting a CAN-Bus signal, a first controller area network module coupled to the CAN-Bus for receiving the CAN-Bus signal transmitted from the CAN-Bus and for transforming the CAN-Bus signal into a message signal, an instrument panel, and a processor coupled to the first controller area network module and the instrument panel for receiving the message signal and for controlling the instrument panel to show information corresponding to the message signal.

According to the claimed invention, the auto-meter system utilizes the CAN-Bus to transmit a signal so as to decrease assembly cables inside the electronic modules. The auto-meter system can be flexibly compatible with many kinds of electronic control device for increasing the efficiency of signal transmission and data processing.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an auto-meter system according to a preferred embodiment of the present invention.

FIG. 2 is a diagram of an instrument panel according to the preferred embodiment of the present invention.

FIG. 3 is a diagram of a third display region according to the preferred embodiment of the present invention.

### DETAILED DESCRIPTION

In the following detailed description and claims of the present invention uses certain words to indicate specific components. It is to be understood that other names may be utilized to indicate the same components within the similar scope. The detailed description and claims of the present invention does not differentiate the components from its names instead of its functions. The use of “including,” “comprising,” or “having” and variations thereof herein is meant to encompass the items listed thereafter and equivalents thereof as well as additional items. The terms “couple,” “coupled” and variations thereof herein are used broadly and encompass direct and indirect electrically connecting. Therefore, the description of a first device coupled to a second device herein may contain the situations that the first device can be connected to the second device directly or one or more additional devices and methods are between the first device and the second device. Accordingly, the drawings and descriptions will be regarded as illustrative in nature and not as restrictive.

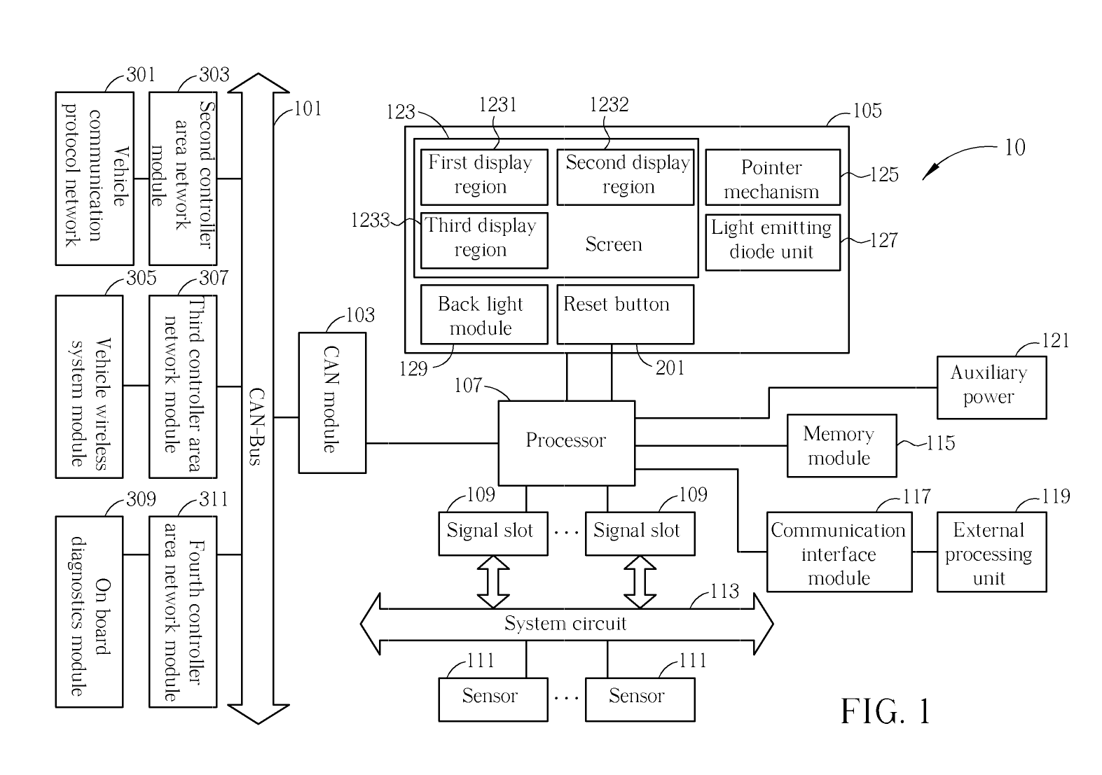

Please refer to FIG. 1. FIG. 1 is a diagram of an auto-meter system 10 according to a preferred embodiment of the present invention. The auto-meter system 10 includes a controller area network bus (CAN-Bus) 101 for transmitting at least one CAN-Bus signal, and a first controller area network (CAN) module 103 coupled to the CAN-Bus 101 for receiving the CAN-Bus signal transmitted from the CAN-Bus 101 and for transforming the CAN-Bus signal into a corresponding message signal. The CAN-Bus module 103 can be electrically connected to the CAN-Bus 101 in a wire transmission manner or in a wireless transmission manner. The auto-meter system 10 further includes an instrument panel 105 and a processor 107 coupled to the first CAN-Bus module 103 and the instrument panel 105 for receiving the message signal and for controlling the instrument panel 105 to show information corresponding to the message signal. The auto-meter system 10 further includes at least one signal slot 109 and at least one sensor 111. The signal slot 109 and the sensor 111 are coupled to a system circuit 113, respectively. The sensor 111 can be an electronic sensor for sensing temperature, pressure, operation of car doors, and so on. The signal slot 109 is for receiving a signal generated by the sensor 111 and for transmitting the signal of the sensor 111 to the processor 107 via the system circuit 113. For example, the sensor 111 can sense whether the car door is close and transmit the corresponding signal to the signal slot 109 via the system circuit 113, and the signal slot 109 transmits the signal to the processor 107.

The auto-meter system 10 further includes a memory module 115 coupled to the processor 107 for storing vehicle driving data. The auto-meter system 10 further includes a communication interface module 117 coupled to the processor 107 and an external processing unit 119 for receiving information transmitted from the external processing unit 119 and transmitting the information to the processor 107. The auto-meter system 10 further includes an auxiliary power 121 electrically connected to the processor 107 for supplying electricity to the processor 107 when a main power failure has occurred. The auxiliary power 121 can be coupled to a built-in power-sensing circuit. When the built-in power-sensing circuit detects power failures, the auto-meter system 10 is under predetermined voltages, or the engine is shut off, the auxiliary power 121 can supply the electricity to the processor 107 so as to store information of mileage, working hours, and so on.

In addition, the instrument panel 105 of the auto-meter system 10 can include a screen 123 for displaying a graph or a numeral so as to represent the information corresponding to the message signal. The instrument panel 105 of the auto-meter system 10 can further include an indicator mechanism 125 driven by a stepping motor. The indicator mechanism 125 can utilize a pulse width modulation signal to drive the stepping motor. The indicator mechanism 125 can further utilize the processor 107 to control an input/output port to simulate the pulse width modulation signal so as to drive the stepping motor. The instrument panel 105 of the auto-meter system 10 can further include an electric induced indicator mechanism and an electromagnetic induced indicator mechanism, selectively. The instrument panel 105 of the auto-meter system 10 can further include at least one light emitting diode unit 127 for showing the information corresponding to the message signal by varying intensity of colors. The instrument panel 105 of the auto-meter system 10 can further include a back light module 129 for supplying light to the screen 123 and the indicator mechanism 125. Method of the instrument panel 105 showing the vehicle driving data is not limited to the above-mentioned and depends on actual design.

The auto-meter system 10 can further include a vehicle communication protocol network 301 and a second controller area network module 303 coupled to the vehicle communication protocol network 301 and the CAN-Bus 101. The second controller area network module 303 is for transforming a signal transmitted from the vehicle communication protocol network 301 into the CAN-Bus signal and for transmitting the CAN-Bus signal to the CAN-Bus 101. The vehicle communication protocol network 301 can include a media oriented system transport (MOST), a X-by-Wire network, a local interconnect network (LIN), and so on.

The auto-meter system 10 can further include a vehicle wireless system module 305 and a third controller area network module 307 coupled to the vehicle wireless system module 305 and the CAN-Bus 101. The third controller area network module 307 is for transforming a signal transmitted from the vehicle wireless system module 305 into the CAN-Bus signal and for transmitting the CAN-Bus signal to the CAN-Bus 101. The vehicle wireless system module 305 can include a global position system (GPS) unit, a Zibee wireless network unit, and so on.

The auto-meter system 10 can further include an on board diagnostics module 309 and a fourth controller area network module 311 coupled to the on board diagnostics module 309 and the CAN-Bus 101. The fourth controller area network module 311 is for transforming a signal transmitted from the on board diagnostics module 309 into the CAN-Bus signal and for transmitting the CAN-Bus signal to the CAN-Bus 101.

As mentioned above, because the vehicle communication protocol network 301, the vehicle wireless system module 305, and the on board diagnostics module 309 respectively transmit the signal to the CAN-Bus 101 via the second controller area network module 303, the third controller area network module 307, and the fourth controller area network module 311. Then the first CAN-Bus module 103 coupled to the CAN-Bus 101 can receive the CAN-Bus signal corresponding to the signal generated by the vehicle communication protocol network 301, the vehicle wireless system module 305, and the on board diagnostics module 309, can transform the CAN-Bus signal into the corresponding message signal, and can control the instrument panel 105 to show the information corresponding to the message signal. That is to say, the instrument panel 105 can show the information generated by the vehicle communication protocol network 301, the vehicle wireless system module 305, and the on board diagnostics module 309 via the connection interface of the CAN-Bus 101, so as to expand compatibility of the instrument panel 105. The functional module connected to the CAN-Bus 101 of the present invention is not limited to the above-mentioned component, and all the functional modules capable of transmitting the signal via the CAN-Bus 101 are within the scope of the present invention.

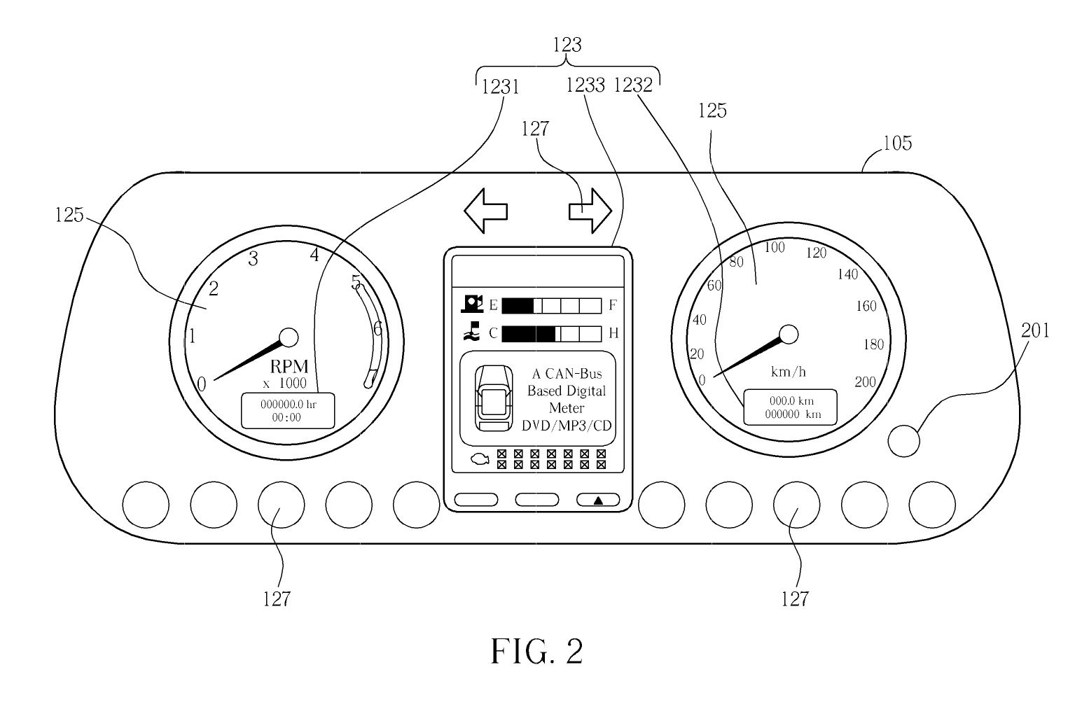

Please refer to FIG. 2. FIG. 2 is a diagram of the instrument panel 105 according to the preferred embodiment of the present invention. The instrument panel 123 includes a first display region 1231, a second display region 1232, and a third display region 1233. The first display region 1231, the second display region 1232, and the third display region 1233 can be utilized for showing driving information of rotational speed of an engine, driving speed, and so on, vehicle information of present time, working hours of the engine, a mileage, warning signals, an air-fuel ratio, a pressure, and so on, and information of service, failure diagnosis, GPS data, and so on. The indicator mechanism 125 can be manipulated to the desired rotational speed of the engine and the driving speed, and therefore panels of a tachometer and a speedometer include corresponding graduations, respectively. The light emitting diode 127 can be a guard lamp for showing driving information of direction lights, low/high beams, a warning light of the lower fuel level, a hand-brake lights, an urgent lights, a warning light of the lower oil pressure, a battery charging indicator light, and so on. The instrument panel 105 further includes a reset button 201 coupled to the processor 107 for resetting the auto-meter system 10.

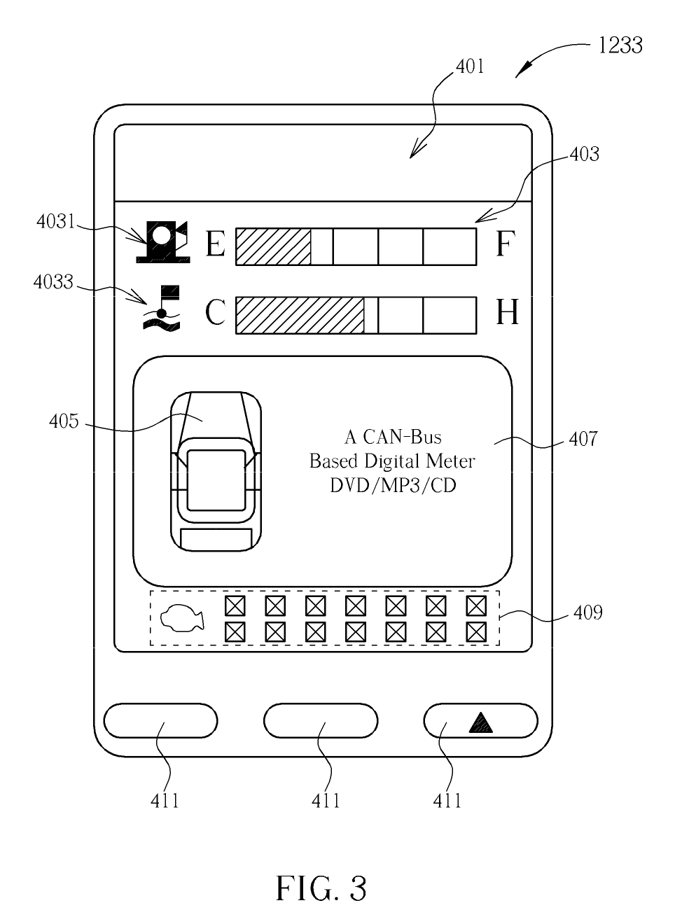

The first display region 1231 and the second display region 1232 of the screen 123 can respectively include the tachometer and the speedometer for showing the driving information of the rotational speed of the engine, the driving speed, the present time, the working hours of the engine, the mileage, and so on, and the service information. Please refer to FIG. 3. FIG. 3 is a diagram of the third display region 1233 according to the preferred embodiment of the present invention. The third display region 1233 is an integrated display region for showing a name zone 401, a driving state zone 403, a system state zone 405, a commentated zone 407, and a warning and diagnostic zone 409. Names shown in the name zone 401 can be predetermined by the system or set by a user. The driving state zone 403 can include a fuel-warning graph 4031 and a temperature graph 4033 for showing the fuel level and the coolant temperature of the engine, respectively. The system state zone 405 can show the failure regions in the vehicle, such as unusual pressure of wheels, the overheated engine, unclosed doors, and so on. The commentated zone 407 can utilize the characters to describe the information briefly, such as a mode of the media player. The warning and diagnostic zone 409 can show a warning sign and diagnoses. In addition, the third display region 1233 further includes a plurality of buttons 411 for setting parameters of the screen 123.

As mentioned above, the auto-meter system including the CAN-Bus of the present invention not only can collect the corresponding information and the service information via the CAN-Bus, but also can receive the signal of the common sensor via the CAN-Bus network and transform the signal of the common sensor into the CAN-Bus signal so as to supply the CAN-Bus signal to the other electronic device connected to the CAN-Bus. In addition, an external setting instrument can be connected to the auto-meter system of the present invention via the communication interface module, so that the user can set the parameters of the auto-meter system according to the actual demand. Thus, the auto-meter system of the present invention has a preferred compatibility.

Comparing to the prior art, the auto-meter system of the present invention utilizes the CAN-Bus to transmit signals, so as to simplify assembly of cables of the electronic modules of the vehicle. Each module on the CAN-Bus can transmit the signal effectively via an arbitration mechanism so as to solve problems of information exchange between the electronic modules. In addition, the auto-meter system of the present invention can set the parameters via the communication interface module and the CAN-Bus, and further can receive the signal of the common sensor and transform the signal of the common sensor into the CAN-Bus signal so as to supply the CAN-Bus signal to the other electronic systems. The auto-meter system of the present invention can be flexibly compatible with different electronic devices and can effectively increase efficiency of the signal transmission and the data processing.

Those skilled in the art will readily observe that numerous modifications and alterations of the device and method may be made while retaining the teachings of the invention.

What is claimed is:

1. An auto-meter system comprising:
a controller area network bus (CAN-Bus) for transmitting a CAN-Bus signal;
a first controller area network module coupled to the CAN-Bus for receiving the CAN-Bus signal transmitted from the CAN-Bus and for transforming the CAN-Bus signal into a message signal;
an instrument panel; and
a processor coupled to the first controller area network module and the instrument panel for receiving the message signal and for controlling the instrument panel to show information corresponding to the message signal.

2. The auto-meter system of claim 1 further comprising:
a vehicle communication protocol network; and
a second controller area network module coupled to the vehicle communication protocol network and the CAN-Bus for transforming a signal transmitted from the vehicle communication protocol network into the CAN-Bus signal and for transmitting the CAN-Bus signal to the CAN-Bus.

3. The auto-meter system of claim 2, wherein the vehicle communication protocol network comprises a media oriented system transport (MOST) network.

4. The auto-meter system of claim 2, wherein the vehicle communication protocol network comprises an X-by-Wire network.

5. The auto-meter system of claim 2, wherein the vehicle communication protocol network comprises a local interconnect network (LIN).

6. The auto-meter system of claim 1 further comprising:
a vehicle wireless system module; and
a third controller area network module coupled to the vehicle wireless system module and the CAN-Bus for transforming a signal transmitted from the vehicle wireless system module into the CAN-Bus signal and for transmitting the CAN-Bus signal to the CAN-Bus.

7. The auto-meter system of claim 6, wherein the vehicle wireless system module comprises a global position system (GPS) unit.

8. The auto-meter system of claim 6, wherein the vehicle wireless system module comprises a Zigbee wireless network unit.

9. The auto-meter system of claim 1 further comprising:
an on board diagnostics module; and
a fourth controller area network module coupled to the on board diagnostics module and the CAN-Bus for transforming a signal transmitted from the on board diagnostics module into the CAN-Bus signal and for transmitting the CAN-Bus signal to the CAN-Bus.

10. The auto-meter system of claim 1 further comprising:
a signal slot coupled to a sensor for receiving a signal of the sensor and for transmitting the signal of the sensor to the processor.

11. The auto-meter system of claim 1 further comprising:
a memory module coupled to the processor for storing vehicle driving data.

12. The auto-meter system of claim 1 further comprising:
a communication interface module connected to the processor and an external processing unit for transmitting a datum transmitted from the external processing unit to the processor.

13. The auto-meter system of claim 1 further comprising:
an auxiliary power connected to the processor for supplying electricity to the processor after a main power failure has occurred.

14. The auto-meter system of claim 1, wherein the first controller area network module is electrically connected to the CAN-Bus in a wire transmission manner.

15. The auto-meter system of claim 1, wherein the first controller area network module is electrically connected to the CAN-Bus in a wireless transmission manner.

16. The auto-meter system of claim 1, wherein the instrument panel comprises a screen for displaying a graph or a numeral so as to represent the information corresponding to the message signal.

17. The auto-meter system of claim 1, wherein the instrument panel comprises an indicator mechanism driven by a stepping motor.

18. The auto-meter system of claim 17, wherein the indicator mechanism utilizes a pulse width modulation signal to drive the stepping motor.

19. The auto-meter system of claim 17, wherein the processor is utilized for controlling an input/output port to simulate the pulse width modulation signal so as to drive the stepping motor.

20. The auto-meter system of claim 1, wherein the instrument panel comprises an electric induced indicator mechanism.

21. The auto-meter system of claim 1, wherein the instrument panel comprises an electromagnetic induced indicator mechanism.

22. The auto-meter system of claim 1, wherein the instrument panel comprises a light emitting diode unit for showing the information corresponding to the message signal by varying intensity of colors.

23. The auto-meter system of claim 1, wherein the first controller area network module is a combination of a universal medium/high speed controller area network receiver/transmitter and a controller area network controller.

24. The auto-meter system of claim 1, wherein the first controller area network module is a combination of a fault tolerant low speed controller area network receiver/transmitter and a controller area network controller.
